(19) United States
(12) Patent Application Publication
(10) Pub. No.: US 2006/0237468 A1
(43) Pub. Date: Oct. 26, 2006

(54) Article holding attachment for receptacles

(75) Inventor: Stephen A. Dukes, North Baltimore, OH (US)

Correspondence Address: FRASER MARTIN & MILLER LLC, 28366 KENSINGTON LANE, PERRYSBURG, OH, 43551, US

(73) Assignee: Impact Products, LLC, Toledo, OH (US)

(21) Appl. No.: 11/358,385

(22) Filed: Feb. 21, 2006

Related U.S. Application Data
(60) Provisional application No. 60/671,016, filed on Apr. 13, 2005.

(51) Int. Cl. B65D 25/00; A47L 13/50; A47J 47/18

(52) U.S. Cl. 220/735; 15/264

(57) ABSTRACT

An article holding attachment for receptacles including a main body having hooks for selective attachment to the rim of a receptacle and means attached to the main body for selectively holding articles for use in janitorial services.

### CROSS-REFERENCE TO RELATED APPLICATION

This application claims priority to U.S. Provisional Patent Application Ser. No. 60/671,016 filed Apr. 13, 2005, the entire disclosure of which is incorporated herein by reference.

### BACKGROUND OF THE INVENTION

1. Field of the Invention

The present invention relates to attachments for receptacles and more particularly to attachments for receptacles used in the janitorial field for holding mops, brooms, brushes, tools, and other related supplies.

2. Description of the Prior Art

Heretofore attachments have been produced for receptacles used in the janitorial field wherein the articles were contained within pockets or the like. While the attachments were generally useful, it was determined that the retrieval of certain of the supplies was difficult and the handling of certain necessary implements was impossible. Therefore, there has been a need to develop an attachment for a receptacle capable of being easily and readily attached to the rim of a receptacle of the type used in the janitorial field and capable of holding the many implements required in the cleaning and maintenance of commercial and industrial installations, for example.

### SUMMARY OF THE INVENTION

It is an object of the present invention to produce an article holding attachment for receptacles capable of holding a wide range of tools and supplies used particularly in the janitorial field.

Another object of the present invention is to produce an article holding device which may be readily removably attached to a receptacle of the type typically used in the janitorial field, wherein the device is capable of holding a member of different and distinctive supplies and tools.

Still another object of the present invention is to produce an article holding device adapted to be removably attached to the rim of the receptacle of the type used in the janitorial field wherein the articles to be held may be easily applied thereto and held in a position which facilitates the selective removal for use and hence storage.

The above objects of the invention may surprisingly be achieved by an article holding device for removable attachment to a supporting rim comprising a main body depending vertically from the supporting rim; hook-like means for removably attaching the main body to the supporting rim; and means for removably holding articles attached to the main body in spaced apart relation from the hook-like means.

### BRIEF DESCRIPTION OF THE DRAWINGS

The above as well as other objects and advantages will become readily manifest to those skilled in the art from reading the following detailed description of a preferred embodiment of the invention when considered in the light of the accompanying drawings, in which:

FIG. 1 is a perspective view of an article holding device for attachment to the rim of a receptacle embodying the features of the present invention;

FIG. 2 is an alternative embodiment of the article holding device illustrated in FIG. 1;

FIG. 3 is a side elevational view of the device illustrated in FIG. 2 with an article holding device attached thereto; and

FIG. 4 is a perspective view of the embodiment illustrated in FIG. 3 with an end effect supported thereby.

### DETAILED DESCRIPTION OF THE PREFERRED EMBODIMENTS

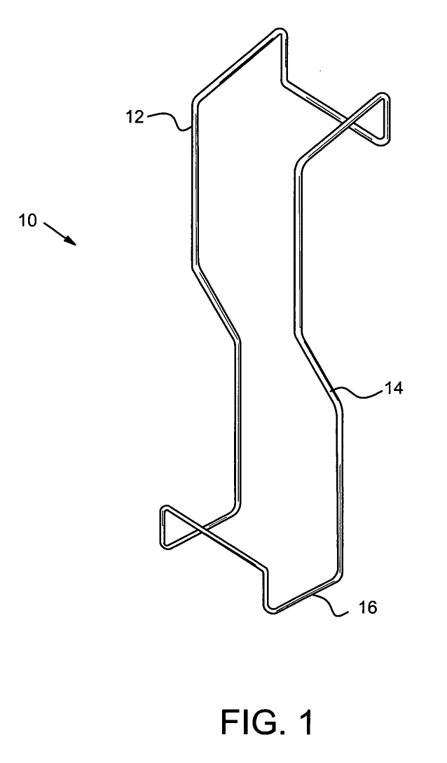

Preferring the FIG. 1 there is shown an article holding device for removable attachment to a supporting rim such as the upper rim of a receptacle of the type generally used in the janitorial field. More specifically, the device is comprised of a wire frame having a main body generally indicated by reference numeral 10. The main body 10 includes an upper section 12 configured to overlap and firmly engage the upper rim of a receptacle. The receptacles are typically formed of a plastic material and may have an upper open rim configuration which may have a rectangular or circular configuration.

A lower section 14 is integral with and depends from the upper section 12 and is configured to usually extend downwardly in a generally parallel relation to the outer surface of the associated receptacle. The lower section 14 terminates in an outwardly and upwardly extending terminal portion 16 for removably holding various articles which would include rags, soap dispensing container, brushes, and the like all useful in the janitorial field, for example.

It will be understood that the sections 12, 14, and 16 are formed of wire material which includes parallel spaced apart members configured as illustrated. The wire material used in the illustrated embodiment may be formed of different materials such as metal or plastic. The material should preferably be resistant to oxidation and inert to the cleaning materials used by the operators of the device.

While wire material has been selected as the preferred material for forming the device of the invention, it will be understood that the device could be formed of a molded plastic material, as well as other materials.

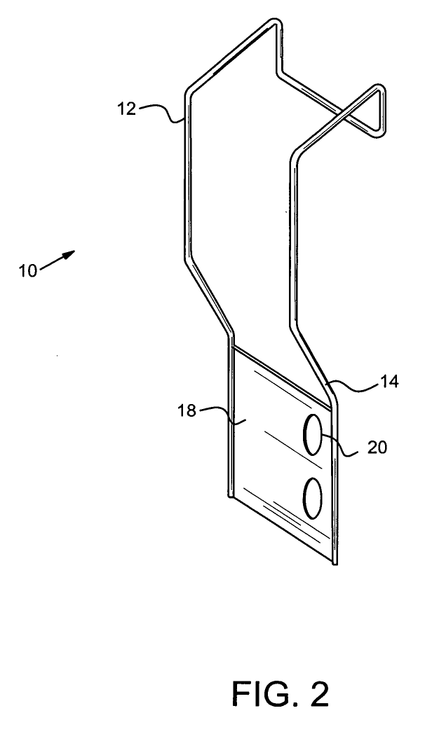

FIG. 2 illustrates another embodiment of the invention wherein the terminal portion 16 of the FIG. 1 embodiment is removed from the main body 10 and a mounting plate 18 is attached to the spaced apart members of the lower section 14.

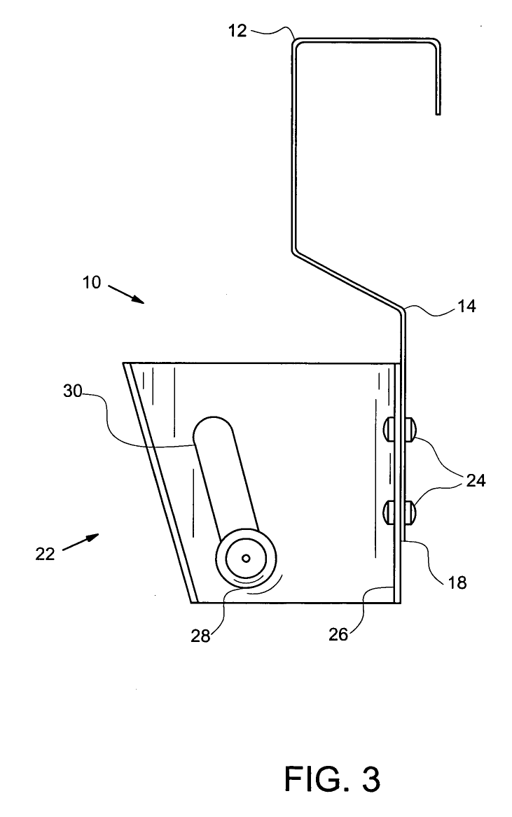

The plate 18 is provided with spaced apart apertures 20 useful in receiving fasteners for attaching an article holding means as illustrated in FIG. 3.

The embodiment illustrated in FIG. 3 shows an attachment generally indicated by reference numeral 22 and referred to as a quick release holder for elongate objects such as for example, brooms, brushes, mops and the like. The attachment 22 includes a shallow U-shaped channel member adapted for horizontal attachment to the plate 18 as with threaded fasteners or rivets 24 mounted holes adapted to mate with the apertures 20. The attachment 22 includes a vertically oriented wall 26 and a coacting roller element 28 supported on a captive shaft which in turn projects vertically from the face of the channel and moves in a slot 30 in the face of the channel so as to move the roller 28 closer to the vertical wall 26 as the shaft and associated roller 28 move downwardly in the slot 30.

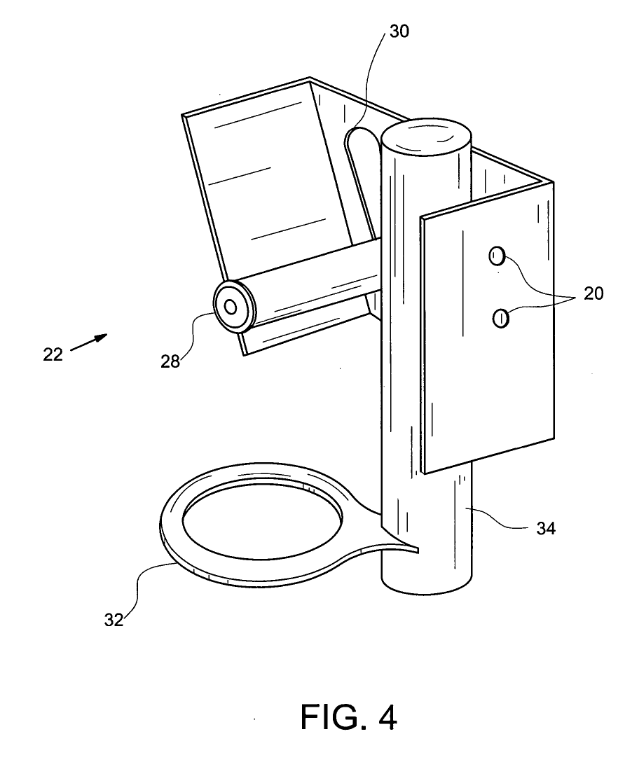

FIG. 4 illustrates the use of the attachment 22 for holding various end effects mounted on a shaft. The particular end effect shown in FIG. 4 is an element 32 molded or otherwise formed integral with a vertically extending shaft 34. It will be understood that the end effect may assume many different configurations with the common objective of holding various articles which may be easily applied and removed therefrom.

From the foregoing description, one ordinarily skilled in the art can easily ascertain the essential characteristics of this invention and, without departing from the spirit and scope thereof, can make various changes and modifications to the invention to adapt it to various usages and conditions.

What is claimed is:

1. An article holding device for removable attachment to a supporting rim comprising:
a main body depending vertically from the supporting rim;
hook-like means for removably attaching the main body to the supporting rim; and
means for removably holding articles attached to the main body in spaced apart relation from the hook-like means.

2. An article holding device as defined in claim 1 wherein the main body is formed of wire.

3. An article holding device as defined in claim 2 wherein the hook-like means is formed of wire.

4. An article holding device as defined in claim 1 wherein the means for removably holding articles includes a downwardly depending plate supporting a channel member containing a vertically slidable roller for selectively holding an article.

5. An article holding device as defined in claim 1 wherein the main body and the hook-like means are formed of cooperating spaced apart wire frames.
